(19) United States
(12) Patent Application Publication
(10) Pub. No.: US 2006/0172196 A1
(43) Pub. Date: Aug. 3, 2006

(54) Non-aqueous electrolyte rechargeable battery and manufacturing method of negative electrode employed therein

(75) Inventor: Masao Fukunaga, Osaka (JP)

Correspondence Address: MCDERMOTT WILL & EMERY LLP, 600 13TH STREET, N.W., WASHINGTON, DC, 20005-3096, US

(73) Assignee: MATSUSHITA ELECTRIC INDUSTRIAL CO., LTD.

(21) Appl. No.: 11/325,318

(22) Filed: Jan. 5, 2006

(30) Foreign Application Priority Data
Jan. 11, 2005 (JP) 2005-003576

(51) Int. Cl. H01M 4/62; H01M 4/58

(52) U.S. Cl. 429/232; 252/182.1; 429/231.95

(57) ABSTRACT

A manufacturing method of a negative electrode for a non-aqueous electrolyte rechargeable battery has a primary kneading step and a secondary kneading step. In the primary kneading step, conductive material, polymer, and a dispersion medium are mixed and primarily kneaded. The conductive material contains at least fibrous carbon of which aspect ratio is at least 10 and at most 10000. In the secondary kneading step after the primary kneading step, active material capable of storing and emitting a lithium ion and another portion of the dispersion medium are added, and secondary kneading is performed. The active material contains at least silicon.

### BACKGROUND OF THE INVENTION

1. Field of the Invention

The present invention relates to a non-aqueous electrolyte rechargeable battery and a manufacturing method of a negative electrode employed therein, and particularly to a manufacturing method of the negative electrode for kneading suitable materials in a suitable order.

2. Background Art

Recently, a lithium-ion rechargeable battery that applies high electromotive force and has high energy density has been required to have more capacity by a market as mobile communication devices and portable electronic devices have been developed. When lithium metal is employed as negative electrode material for a lithium rechargeable battery, the energy density is high, but dendrite grows on a surface of the negative electrode when charge and discharge are repeated. Therefore, the charge-discharge efficiency decreases, namely the charge-discharge cycling characteristics (hereinafter referred to as “cycling characteristics”) is low. The dendrite can also cause an internal short circuit, and there may be a problem on safety. Therefore, a non-aqueous electrolyte rechargeable battery is commercialized where negative electrode is made of carbon material such as graphite that can reversibly store and emit lithium (Li) ions and has a high cycling characteristics and high safety. However, the theoretical capacity of the graphite used for the negative electrode is about 372 mAh/g, namely only about 1/10 of that of metallic lithium. A commercialized battery is designed to use the capacity of about 350 mAh/g, namely substantially close to the theoretical capacity. Therefore, further increase in capacity of the battery using the carbon material is limited.

Thus, alloy material including elements such as silicon (Si) and tin (Sn) becomes a focus of attention as negative electrode material. Certain metal elements such as Si and Sn can store and emit Li electrochemically. They have theoretical capacity more than that of the carbon material, and hence allow capacity of a battery to be increased. For example, the theoretical capacity of Si is about 4199 mAh/g, namely about 11 times more than that of graphite. In storing Li ions, however, an alloy material including such elements expands largely in the crystal structure. When Si stores Li ions at a maximum for example, it is theoretically considered that the expansion about four times larger than that in the case where Si does not store Li ions occurs. Similarly, regarding Sn, it is considered that about 3.8 times expansion occurs. On the contrary regarding graphite, about 1.1 times expansion, namely only slight expansion, occurs because the graphite stores Li ions by the intercalation reaction. Here, in the intercalation reaction, the Li ions are inserted into a gap between graphite layers. Stress caused by the expansion in alloy material is extremely larger than that in graphite. This expansion extremely reduces the cycling characteristics comparing with that of the carbon material. This phenomenon is described hereinafter.

The electrical conductivity of the alloy material is lower than that of graphite, so that a conductive assistant such as carbon material must be added to the alloy material. As the conductive assistant, particulate carbon such as carbon black is generally employed. When charge and discharge are repeated, however, the stress in expansion and contraction disconnects the conductive network structure of conductive material and disables securement of the electrical conductivity. In other words, when the alloy material is employed, the reduction in conductivity in a negative electrode mixture layer becomes a cause of significant reduction of the cycling characteristics.

Japanese Patent Unexamined Publication No. 2001-196052, for example, discloses that fibrous carbon as the conductive material is included with such largely expanding/contracting alloy material in order to secure the conductive network structure. According to this publication, the containing of the fibrous carbon improves the cycling characteristics. However, the fibrous carbon, especially carbon material having high aspect ratio, has high cohesiveness. Therefore, even when fibrous carbon is added as powder to mixture paste used for producing the negative electrode mixture layer and the paste is stirred, the powder is hardly dispersed homogeneously. In other words, the conductive network structure of the fibrous carbon is not utilized sufficiently.

An example where the dispersibility of conductive carbon or graphite is improved by previously kneading conductive material with a binder in order to improve the dispersibility of the conductive material is disclosed in Japanese Patent Unexamined Publication No. 2001-283831. In this method, particulate carbon such as carbon black or graphite is relatively easily dispersed. However, an amount of polymer is insufficient, and hence the fibrous carbon having extremely high cohesiveness cannot be sufficiently dispersed.

### SUMMARY OF THE INVENTION

A manufacturing method of a negative electrode for a non-aqueous electrolyte rechargeable battery of the present invention includes a primary kneading step and a secondary kneading step. In the primary kneading step, conductive material, polymer, and a dispersion medium are mixed and primarily kneaded. The conductive material contains at least fibrous carbon of which aspect ratio is at least 10 and at most 10000. In the secondary kneading step after the primary kneading step, active material capable of storing and emitting a lithium ion and another portion of the dispersion medium is added, and secondary kneading is performed. The active material contains at least silicon. The non-aqueous electrolyte rechargeable battery of the present invention employs a negative electrode manufactured by the above-mentioned manufacturing method. The dispersibility of the fibrous carbon can be improved in the present invention, so that significant reduction in conductivity can be suppressed even in the negative electrode made of alloy material or the like that significantly expands in storing the Li ions. The present invention can provide a non-aqueous electrolyte rechargeable battery capable of reconciling large capacity with sufficient cycling characteristics.

### BRIEF DESCRIPTION OF THE DRAWINGS

FIG. 1 is a sectional view of a structure of a non-aqueous electrolyte rechargeable battery in accordance with an exemplary embodiment of the present invention.

FIG. 2 is a flow chart showing a producing method of negative electrode mixture paste in accordance with the exemplary embodiment of the present invention.

FIG. 3 is a flow chart showing another producing method of negative electrode mixture paste in accordance with the exemplary embodiment of the present invention.

FIG. 4 is a flow chart showing a producing method of negative electrode mixture paste in comparative sample 1.

FIG. 5 is a flow chart showing a producing method of negative electrode mixture paste in comparative sample 2.

FIG. 6 is a flow chart showing a producing method of negative electrode mixture paste in comparative sample 3.

FIG. 7 is a flow chart showing a producing method of negative electrode mixture paste in comparative sample 4.

### DETAILED DESCRIPTION OF THE INVENTION

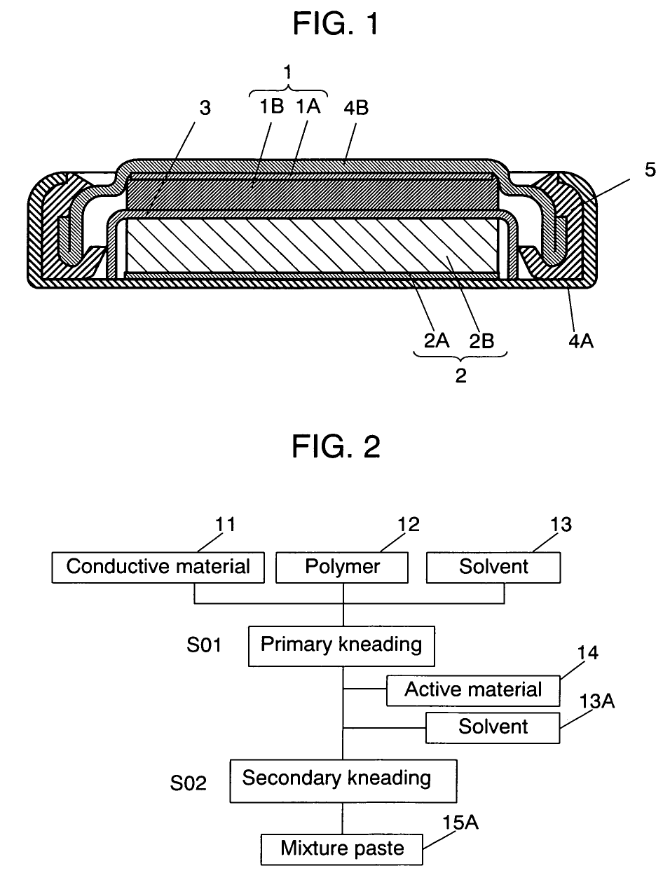

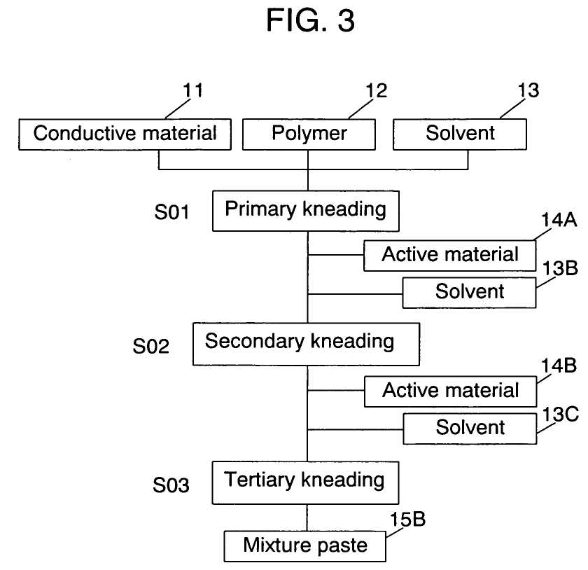

FIG. 1 is a schematic sectional view of a coin-shaped battery as a non-aqueous electrolyte rechargeable battery in accordance with an exemplary embodiment of the present invention. FIGS. 2 and 3 are flow charts showing manufacturing methods of negative electrodes in accordance with the exemplary embodiment of the present invention.

As shown in FIG. 1, the non-aqueous electrolyte rechargeable battery in accordance with the exemplary embodiment includes negative electrode 1, positive electrode 2, and separator 3. Separator 3 is disposed between negative electrode 1 and positive electrode 2, and prevents direct contact of negative electrode 1 with positive electrode 2. Negative electrode 1, positive electrode 2, and separator 3 are impregnated with electrolytic solution (not shown) as electrolyte. The electrolytic solution contains a non-aqueous solvent.

Negative electrode 1 and positive electrode 2 are laminated via separator 3. The laminated body is sandwiched by positive electrode can 4A and negative electrode can 4B that are electrically insulated from each other by gasket 5. The electrolytic solution regulated by dissolving supporting salt in an organic solvent is injected into at least one of positive electrode can 4A and negative electrode can 4B, and the cans are sealed, thereby forming a coin-shaped lithium rechargeable battery.

Negative electrode 1 has collector 1A and mixture layer 1B that is disposed on collector 1A and includes active material 14 and conductive material 11. Active material 14 included in mixture layer 1B contains at least silicon (Si), and can store and emit Li ions. Conductive material 11 contains at least fibrous carbon of which aspect ratio is at least 10 and at most 10000. This is described later in detail.

Mixture layer 1B further includes a binder of polymer 12. Mixture layer 1B is produced by coating collector 1A with mixture paste 15A composed of active material 15A, conductive material 11, the binder of polymer 12, and solvents 13 and 13A, and by drying them. Rolling may be performed after the drying.

As the binder, a publicly known binder generally used in such a battery may be employed. A thickener may be added to mixture paste 15A. In other words, polymer 12 of FIG. 2 contains at least the binder, and can further contain the thickener. Collector 1A can be made of metal such as copper or nickel. Negative electrode 1 is formed by coating collector 1A with mixture paste 15A, drying them, rolling them if necessary, and cutting or stamping them out with a die into a predetermined size.

Positive electrode 2 includes a lithium complex oxide capable of storing and emitting Li ions as positive electrode active material, a binder, and a conductive agent. As the active material, various complex oxides such as lithium cobaltate (including a eutectic crystal of oxide of such as aluminum or magnesium), lithium nickelate (including a substitution product of cobalt or the like), and lithium manganate can be employed.

As the binder, material similar to that of negative electrode 1 can be employed. In other words, as the binder for the positive electrode, publicly known poly-vinylidene fluoride (PVDF) and its modified product can be employed. Collector 2A can be made of metal such as aluminum, stainless steel, or titanium. As the conductive material, carbon black such as acetylene black (AB), Ketjen black, channel black, furnace black, lamp black, or thermal black, various graphite, and fibrous carbon may be individually used, or a combination of them may be used.

These materials are kneaded with water or an organic solvent, and then collector 2A is coated with the kneaded material and is dried. The intermediate product is rolled and then cut or stamped out with a die into a predetermined size. Thus, positive electrode 2 is obtained. Furthermore, positive electrode 2 may be formed by granulating a mixture of active material, micro graphite, a conductive agent such as carbon black, and a binder by made by a kneading method or the like with water or an organic solvent, then molding the granulated product in a pellet shape of the predetermined size, and drying the molded product.

Separator 3 is not especially limited when it has a composition durable in a working range of the non-aqueous electrolyte rechargeable battery. Generally, a micro-porous film made of olefin resin such as polyethylene or polypropylene is preferably used singly or compositely. The thickness of separator 3 is not especially limited, but is preferably 10 to 25 μm.

Electrolytic solution as lithium ion conducting electrolyte is obtained by dissolving supporting salt in a non-aqueous solvent. As the non-aqueous solvent, ethylene carbonate (EC), dimethyl carbonate (DMC), diethyl carbonate (DEC), and methyl ethyl carbonate (MEC) may be individually used, or a combination of them may be used. For forming sufficient coating on the positive and negative electrodes or guaranteeing the stability in overcharge, vinylene carbonate (VC), cyclohexylbenzene (CHB), and their modified products may be employed.

The supporting salt is not especially limited when it is lithium salt that dissolves in a non-aqueous solvent and has ion conductivity. For example, LiPF₆, LiClO₄, LiAsF₆, LiBF₄, LiB(C₆H₅)₄, LiCH₃SO₃, CF₃SO₃Li, LiCl, LiN(CₙC₂ₙ₊₁SO₂)₂, or LiBr may be used. Especially, LiPF₆ is preferably used as the electrolyte. One of these electrolytes may be singly used, or a mixture of two or more of them may be used.

As material of positive electrode can 4A, iron, nickel, stainless steel, aluminum, or titanium can be used. As material of negative electrode can 4B, material similar to that of positive electrode can 4A except for aluminum can be used. For preventing electrochemical corrosion due to non-aqueous electrolyte caused by charge or discharge of the battery, positive electrode can 4A and negative electrode can 4B may be coated with plating or the like.

A battery having the structure of FIG. 1 is manufactured as following. A laminated body is formed so that separator 3 is disposed between negative electrode 1 and positive electrode 2. The laminated body is inserted into one of positive electrode can 4A and negative electrode can 4B. One of positive electrode can 4A and negative electrode can 4B into which the laminated body is inserted is filled with a predetermined amount of electrolytic solution. Positive electrode can 4A is engaged with negative electrode can 4B via gasket 5. Thus, electrolyte is disposed between positive electrode 2 and negative electrode 1. Finally, positive electrode can 4A is caulked to deform and compress gasket 5, thereby completing a coin-shaped battery.

Next, a regulating method of mixture paste 15A for forming mixture layer 1B is described with reference to FIG. 2. In S01, conductive material 11 and polymer 12 are wetted by solvent 13 as a dispersion medium. Conductive material 11 contains at least fibrous carbon of which aspect ratio is at least 10 and at most 10000. Primary kneading is performed in a high viscosity state. Thus, fibrous carbon paste where fibrous carbon is dispersed homogeneously in the polymer is regulated.

For increasing the viscosity and shearing force, it is preferable to set the added weight of polymer 12 in the primary kneading to be 2 to 6 times larger than that of the fibrous carbon. A dispersing method at this time can employ various dispersing machines such as a biaxial kneading machine, three rolls, and a kneader.

In S02, active material 14 and solvent 13A as an additional dispersion medium are added to the kneaded product. Thus, the viscosity of the kneaded product is regulated to a viscosity optimum for application to collector 1A, thereby regulating mixture paste 15A.

As active material 14 for negative electrode 1, metal capable of being alloyed with lithium is used. Above all, an element such as Si or Sn is preferable, and especially Si is more preferable. Si and Sn have low conductivity, so that composite particles of these elements and alloys of the elements may be used as an active material. As the Si alloy, specifically, a compound represented by MₓSi (M is one or more metal elements other than Si), namely SiB₄, SiB₆, Mg₂Si, Ni₂Si, TiSi₂, MoSi₂, CoSi₂, NiSi₂, CaSi₂, CrSi₂, Cu₅Si, FeSi₂, MnSi₂, NbSi₂, TaSi₂, VSi₂, WSi₂, or ZnSi₂, can be used. Si and a 4B group element except for carbon that includes one or more non-metal elements may be also used as active material 14. This material may include one or more 4B group elements. For example, SiC, Si₃N₄, Si₂N₂O, SiOₓ (where, 0<x≦2), or LiSiO is used.

As conductive material 11, various fibrous carbon material such as carbon nano tube, carbon nano fiber, and vapor growth carbon fiber (VGCF) can be used. Carbon black such as acetylene black (AB), Ketjen black (KB), channel black, furnace black, lamp black, or thermal black, and various graphite may be used in combination with the fibrous carbon.

The aspect ratio of the fibrous carbon may be set at least 10 and at most 10000, more preferably at least 10 and at most 1000. Such fibrous carbon is used in conductive material 11, and mixture paste 15A is regulated in the above-mentioned method, thereby suppressing significant reduction in conductivity even in expansion of alloy material. In other words, the cycling characteristics of the battery can be largely improved.

Fibrous carbon of which aspect ratio is lower than 5 cannot keep a conductive network structure because the alloy material stores and emits Li ions and expands largely to generate stress in charging or discharging. When the aspect ratio exceeds 10000, the cohesiveness of the fibrous carbon becomes large, and hence fibrous carbon is not homogeneously dispersed even in the mixture paste producing method as described above. Therefore, either case is not preferable because the cycling characteristics decrease.

The added amount of the fibrous carbon is preferably at least 3 parts-by-weight and at most 12 parts-by-weight per 100 parts-by-weight of active material, and more preferably at least 4 parts-by-weight and at most 8 parts-by-weight. When the added amount is less than 3 parts-by-weight, the stress in expansion of active material 14 disables the keeping of the conductive network structure. When the added amount exceeds 12 parts-by-weight, a reaction of conductive material 11 and electrolytic solution generates gas, and the reaction distance between positive electrode 2 and negative electrode 1 becomes longer. Either case is not preferable because the cycling characteristics decrease.

As polymer 12, PVDF, its modified product, and various binders can be employed. Styrene-butadiene copolymer rubber particles (SBR), its modified product, and a thickener such as cellulosic resin like carboxymethyl cellulose (CMC), polyacrylic acid (PAA), polyvinyl alcohol (PVA), polyethylene oxide (PEO) and the like can be added concurrently in small amounts. When a plurality of polymers are used, it is preferable for increasing shearing force that the polymer having high thickening effect is added in the primary kneading. In this case, materials other than the polymer added in S01 can be added in the secondary kneading.

A study result of a specific kneading method using a lithium ion battery as one example of non-aqueous electrolyte rechargeable batteries is described hereinafter.

As active material 14, Ti—Si alloy material is produced. Si particles (purity is 99.9% and average particle size is 20 μm) and Ti particles (purity is 99.9%) are mixed at the weight ratio of Si:Ti=60:40. Then, alloy material having an average particle size of about 17 to 23 μm is produced in a gas atomizing method. The X-ray diffraction (XRD) profile of the produced alloy material has a plurality of peaks indicating a crystalline phase. The produced alloy material and stainless-steel balls (alloy:ball=1:10 (weight ratio)) are then crushed mechanically by an attritor ball mill. This process is performed under argon (Ar) atmosphere for three hours at a fixed number of revolution rate of 6000 rpm. Thus, powder of alloy material is produced as active material 14. The powder is extracted under Ar atmosphere without contacting with air. As a result of crystal structure analysis by XRD and observation by a transmission electron microscope (TEM), the produced Ti—Si powder is recognized to be an amorphous alloy having at least an Si phase and a phase made of a metal compound of TiSi₂.

Next, negative electrode 1 is produced using active material 14 prepared in the above-mentioned method. In other words, in the flow chart of FIG. 2, mixture paste 15A is produced using active material 11, conductive material 11, and polymer 12, and solvent 13. Here, 10 g of active material 11 is used. As conductive material 11, 0.6 g of fibrous carbon power (VGCF) having aspect ratio of 100 is used. As polymer 12, 20.0 g of N-2-methyl pyrolidone (NMP) solution (solid part weight ratio: 12.0 wt %) of PVDF is used. As solvent 13, NMP is used. In other words, conductive material 11, polymer 12, and solvent 13 are primarily kneaded by a dual-arm-type kneading machine (S01) to sufficiently improve dispersibility of VGCF. Active material 14 and the NMP as additional solvent 13A are added to the primary kneaded product, and secondary kneading is then performed, thereby obtaining mixture paste 15A.

Next, copper foil as collector 1A is coated with mixture paste 15A by a knife coater so that the thickness of the mixture is about 70 μm after drying. After coating, air blowing and drying are performed at 60° C. in the atmosphere. A negative electrode hoop is stamped out with a die into a shape of diameter of 55 mm to form negative electrode 1.

Positive electrode 2 is produced as below. LiCoO₂ as positive electrode active material is synthesized by mixing Li₂CO₂ and CoCO₃ at a predetermined molar ratio and heating them at 950°. The synthesized product is classified as a size of 100 meshes or less. Three grams of acetylene black as the conductive material and 33.3 of NMP solution of PVDF as the binder are used in 100 g of the positive electrode material; they are sufficiently mixed, thereby producing mixture paste for positive electrode. Collector 2A of aluminum is coated with the paste, and dried, pressed, and stamped out with a die into a shape of diameter of 50 mm, thereby forming positive electrode 2.

Positive electrode 2 and negative electrode 1 produced as discussed above and a separator of 27 μm thickness made of polyethylene are sufficiently impregnated with electrolytic solution. The electrolytic solution is regulated by dissolving LiPF₆ in a mixed solvent of ethylene carbonate and diethyl carbonate (volume ratio is 1:3) so as to provide concentration of 1 mol/dm³. Separator 3 is sandwiched by positive electrode 2 and negative electrode 1. Thus, a battery of sample 1 is produced.

Next, a manufacturing method of a battery of sample 2 is described with reference to FIG. 3. In the manufacturing method of sample 1 shown in FIG. 2, active material 14 and NMP as additional solvent 13A are added collectively in S02 for secondary kneading. While, in sample 2, a half each material is added. In other words, in S02, active material 14A, half amount of active material 14, and solvent 13B, half amount of solvent 13A, are added. After S02, remaining half amounts of active material 14B and solvent 13C are added, and tertiary kneading is performed (S03). Thus, mixture paste 15B is prepared. Except for this process, negative electrode 1 is obtained in a producing procedure similar to that in sample 1. Positive electrode 2 same as that in sample 1 is used, and a battery is produced similarly to sample 1.

For comparing with the batteries of samples 1 and 2, batteries of comparative samples 1 to 4 are produced.

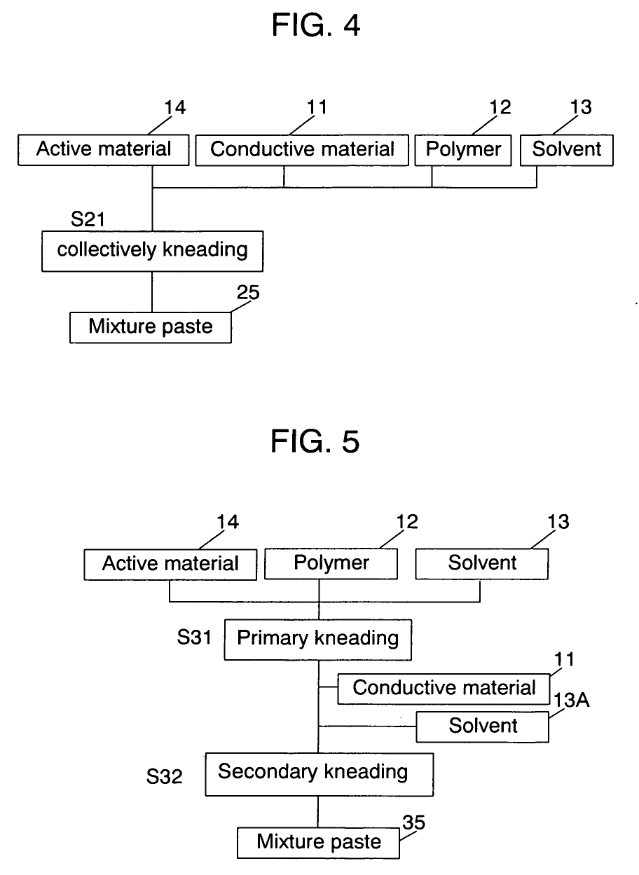

A battery of comparative sample 1 is produced as below. Negative electrode 1 is firstly produced as shown in the flow chart of FIG. 4. In S21, active material 14, conductive material 11 of VGCF, polymer 12 of PVDF, and solvent 13 of NMP are added collectively, and are kneaded to provide mixture paste 25. Except for this process, negative electrode 1 is obtained in a producing procedure completely similar to that in sample 1. Positive electrode 2 same as that in sample 1 is used, and a battery of comparative sample 1 is produced similarly to sample 1.

A battery of comparative sample 2 is produced as below. Negative electrode 1 is firstly produced as shown in the flow chart of FIG. 5. In S31, the primary kneading is performed using active material 14, polymer 12 of PVDF, and solvent 13 of NMP. Conductive material 11 of VGCF and NMP as additional solvent 13A are then added to the primary kneaded product, and the secondary kneading is performed (S32). Thus, mixture paste 35 is obtained. Except for this process, negative electrode 1 is obtained in a producing procedure completely similar to that in sample 1. Positive electrode 2 same as that in sample 1 is used, and a battery of comparative sample 2 is produced similarly to sample 1.

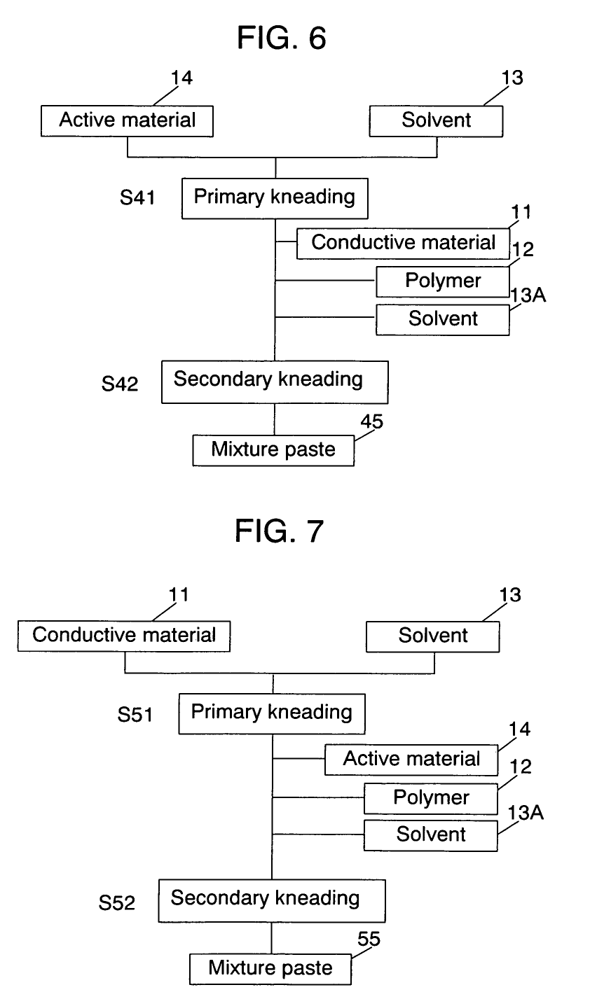

A battery of comparative sample 3 is produced as below. Negative electrode 1 is firstly produced as shown in the flow chart of FIG. 6. In S41, the primary kneading is performed using active material 14 and solvent 13 of NMP. Conductive material 11 of VGCF, polymer 12 of PVDF, and NMP as additional solvent 13A are then added to the primary kneaded product, and the secondary kneading is performed (S42). Thus, mixture paste 45 is obtained. Except for this process, negative electrode 1 is obtained in a producing procedure completely similar to that in sample 1. Positive electrode 2 same as that in sample 1 is used, and a battery of comparative sample 3 is produced similarly to sample 1.

A battery of comparative sample 4 is produced as below. Negative electrode 1 is firstly produced as shown in the flow chart of FIG. 7. In S51, the primary kneading is performed using conductive material 11 of VGCF and solvent 13 of NMP. Active material 14, polymer 12 of PVDF, and NMP as additional solvent 13A are then added to the primary kneaded product, and the secondary kneading is performed (S52). Thus, mixture paste 55 is obtained. Except for this process, negative electrode 1 is obtained in a producing procedure completely similar to that in sample 1. Positive electrode 2 same as that in sample 1 is used, and a battery of comparative sample 4 is produced similarly to sample 1.

The battery of each sample produced as above is evaluated in the following method. Each battery is firstly charged at a constant current of 0.2 C until the voltage becomes 4.05 V. The battery is then charged at a constant voltage of 4.05 V until the charging current becomes 0.01 C. The battery is then discharged at a constant current of 0.2 C until the voltage becomes 2.5 V. Here, 0.2 C is equivalent to a current value at which the designed capacity is discharged in 5 hours.

At the second charge and discharge and thereafter, the battery is charged at a constant current of 1 C until the voltage becomes 4.05 V, and then charged at a constant voltage of 4.05 V until the charging current becomes 0.05 C. Then, the battery is discharged at a constant current of 1 C until the voltage becomes 2.5 V. This charge and discharge cycling is repeated. All these batteries are charged and discharged in a thermostatic chamber in which temperature is set at 20° C. Thus, the ratio of the battery capacity of the 100th cycle to the battery capacity of the second cycle is determined, and is used as the capacity retention rate. As the capacity retention rate is close to 100, the charge and discharge cycling characteristics becomes high. Table 1 shows parameters and evaluation results of each battery.

TABLE 1

| | Conductive | Kneading | Capacity retention |
|---|---|---|---|
| | material | method | rate (%) |
| Sample 1 | VGCF | | 83 |
| Sample 2 | VGCF | | 85 |
| Comparative sample 1 | VGCF | | 43 |
| Comparative sample 2 | VGCF | | 41 |
| Comparative sample 3 | VGCF | | 40 |
| Comparative sample 4 | VGCF | | 45 |

Table 1 shows that the capacity retention rates are high in samples 1 and 2 where conductive material 11 of VGCF is primarily kneaded with polymer 12 of PVDF to improve the dispersibility. On the contrary in comparative sample 1 where all materials are kneaded collectively in the primary kneading, or in comparative samples 2 and 3 where conductive material 11 is added in the secondary kneading or later, the capacity retention rates are low. It is considered that it is because VGCF as the fibrous carbon is not sufficiently dispersed in mixture pastes 25, 35 and 45. Therefore, the stress by expansion and contraction in charge and discharge disables keeping of the conductive network structure to significantly reduce the conductivity.

In comparative sample 4, fibrous carbon is dispersed by primary kneading, but polymer 12 is not added in the primary kneading. In this case, the paste does not have sufficient viscosity in the primary kneading, and a shearing force enough to disperse the fibrous carbon is not obtained. It is considered it because of the reason that the capacity retention rate is low.

According to the results described above, it is expected that a non-aqueous electrolyte rechargeable battery having high cycling characteristics can be realized using the manufacturing method of the present embodiment.

A study result of the types of conductive materials 11 is described.

Negative electrode 1 is produced in the flow chart of FIG. 2, and batteries of samples 3 to 9 and comparative samples 5 to 9 are produced. In comparative sample 5 and sample 3, VGCF having aspect ratio of 5 and VGCF having aspect ratio of 100 are used as conductive materials 11, respectively. In samples 4 and 5 and comparative sample 6, carbon nano fibers having aspect ratios of 1000, 10000, and 50000 are used as conductive materials 11, respectively. In comparative samples 7 to 9, acetylene black, Keten black, and artificial flake graphite are used as conductive materials 11, respectively. Except for these, the batteries are produced similarly to that in sample 1.

Next, capacity retention rates of these batteries at 100th cycle are evaluated in a method similar to that in sample 1. Table 2 shows parameters and evaluation results of each battery.

TABLE 2

| | | | Capacity retention |
|---|---|---|---|
| | Conductive material | Aspect ratio | rate (%) |
| Comparative | VGCF | 5 | 53 |
| sample 5 | | | |
| Sample 3 | VGCF | 10 | 80 |
| Sample 1 | VGCF | 100 | 83 |
| Sample 4 | Carbon nano fiber | 1000 | 85 |
| Sample 5 | Carbon nano fiber | 10000 | 81 |
| Comparative | Carbon nano fiber | 50000 | 69 |
| sample 6 | | | |
| Comparative | AB | (Particulate) | 54 |
| sample 7 | | | |
| Comparative | KB | (Particulate) | 59 |
| sample 8 | | | |
| Comparative | Artificial flake | (Scale-like) | 49 |
| sample 9 | graphite | | |

The capacity retention rates are high in samples 1 and 3 to 5 where fibrous carbon such as VGCF and carbon nano fiber that has aspect ratios of 10 to 10000 is used as conductive material 11. However, in comparative sample 5 where fibrous carbon having aspect ratio lower than 10 is used, in comparative samples 7 and 8 where particulate carbon such as AB and KB is used, and in comparative sample 9 where graphite is used, the capacity retention rates are low. That is because the stress by expansion and contraction disables keeping of the conductive network structure of conductive material 11 to significantly reduce the conductivity.

The capacity retention rate is low also in comparative sample 6 where fibrous carbon having aspect ratio of 50000 is used. When fibrous carbon having aspect ratio exceeding 10000 is used, the cohesiveness is extremely high, and the fibrous carbon cannot be homogeneously dispersed even in the producing method of mixture paste 15A shown in FIG. 2. Therefore, in expansion and contraction, the conductive network structure cannot be kept.

The above-mentioned results show that fibrous carbon having aspect ratio of at least 10 and at most 10000 must be used as conductive material 11 in order to sufficiently use the manufacturing method of the present invention. Fibrous carbon having aspect ratio of 10 to 1000 is preferable.

A study result of the added amount ratio between conductive material 11 and polymer 12 in the primary kneading is described hereinafter.

Negative electrode 1 is produced in the flow chart of FIG. 2, and batteries of samples 6 to 9 are produced. In samples 6 to 9, added weights of PVDF in the primary kneading are set at 0.9, 1.2, 3.6, and 4.8 g, respectively. Except for these, the batteries of samples 6 to 9 are produced in a producing procedure completely similar to that in sample 1.

Next, capacity retention rates of these batteries at 100th cycle are evaluated in a method similar to that in sample 1. Table 3 shows parameters and evaluation results of each battery.

TABLE 3

| | | Weight ratio of | Capacity |
|---|---|---|---|
| | Added amount of | PVDF/VGCF | retention rate |
| | PVDF | in primary kneading | (%) |
| Sample 6 | 0.9 | 1.5 | 71 |
| Sample 7 | 1.2 | 2 | 81 |
| Sample 1 | 2.4 | 4 | 83 |
| Sample 8 | 3.6 | 6 | 80 |
| Sample 9 | 4.8 | 8 | 73 |

According to Table 3, the capacity retention rates are especially high in samples 1, 7, and 8 where the added weights of polymer 12 in the primary kneading are 2.0 to 6.0 times larger than the added weights of fibrous carbon. At these added weight ratios, the kneaded products during the primary kneading have high viscosity, and the shearing force is high. The dispersibility of the fibrous carbon can be therefore improved.

On the contrary in sample 6 where the added weight of polymer 12 in the primary kneading is less than 1.5 times larger than the added weight of the fibrous carbon, the capacity retention rate is slightly low. It is considered that is because the weight of polymer 12 is small regarding to the weight of conductive material 11 and the kneaded product has slightly low viscosity. In other words, that is because a shearing force enough to disperse the fibrous carbon is not obtained.

In sample 9 where the added weight of polymer 12 in the primary kneading is not less than 8 times larger than the added weight of the fibrous carbon, sufficient shearing force is not obtained and polymer 12 as an electrical insulator increases. Therefore, the conductivity in mixture layer 1B decreases and the capacity retention rate also slightly decreases.

As a result, it is preferable that the added weight of polymer 12 in the primary kneading is 2.0 to 6.0 times larger than the added weight of the fibrous carbon for sufficiently using the manufacturing method of the present invention.

A study result of the added amount of the fibrous carbon is described hereinafter.

Negative electrode 1 is produced in the flow chart of FIG. 2, and batteries of samples 10 to 16 are produced. In samples 10 to 16, added weights of the fibrous carbon in the primary kneading are set at 0.2, 0.3, 0.4, 0.8, 1.0, 1.2, and 1.5 g, respectively. Except for these, the batteries of samples 10 to 16 are produced in a producing procedure completely similar to that in sample 1.

Next, capacity retention rates of these batteries at 100th cycle are evaluated in a method similar to that in sample 1. Table 4 shows parameters and evaluation results of each battery.

TABLE 4

| | | Parts-by-weight of | |
|---|---|---|---|
| | Added amount of | VGCF | Capacity |
| | VGCF | (parts-by-weight) | retention rate (%) |
| Sample 10 | 0.2 | 2 | 73 |
| Sample 11 | 0.3 | 3 | 76 |
| Sample 12 | 0.4 | 4 | 81 |
| Sample 1 | 0.6 | 6 | 83 |
| Sample 13 | 0.8 | 8 | 81 |
| Sample 14 | 1.0 | 10 | 77 |
| Sample 15 | 1.2 | 12 | 76 |
| Sample 16 | 1.5 | 15 | 73 |

According to Table 4, the capacity retention rates are especially high in samples 1 and 11 to 15 where the added amounts of the fibrous carbon are 3 to 12 parts-by-weight per 100 parts-by-weight of the active material.

In sample 10 where the added amount of the fibrous carbon is 2 parts-by-weight or less per 100 parts-by-weight of active material, the conductivity is slightly insufficient even when the mixture paste producing method shown in FIG. 2 is used. Thus, the capacity retention rate is slightly low.

In sample 16 where the added amount of the fibrous carbon is 12 parts-by-weight or more per 100 parts-by-weight of active material, gas is generated by a reaction of electrolytic solution and the fibrous carbon. Therefore, it is considered that the reaction distance between positive electrode 2 and negative electrode 1 becomes longer, and the capacity retention rate decreases.

As a result, it is preferable that the added amount of the fibrous carbon contained in conductive material 11 is 3 to 12 parts-by-weight per 100 parts-by-weight of active material for sufficiently using the manufacturing method of the present invention.

Non-aqueous electrolytic solution is used as the electrolyte in the present embodiment; however, gel electrolyte produced by adding a gelling agent to such electrolytic solution may be used. Solid electrolyte may be also used. The shape of the battery is not limited to the coil shape. The manufacturing method of the present invention may be applied to the negative electrode of a cylindrical battery or a prismatic battery. Here, in such batteries, long positive electrode and negative electrode are wound via a separator to form an electrode body.

As described above, the non-aqueous electrolyte rechargeable battery employing the negative electrode produced by the manufacturing method of the present invention has high cycling characteristics. Therefore, the non-aqueous electrolyte rechargeable battery has both high capacity and high cycling characteristics. The non-aqueous electrolyte rechargeable battery is useful as a portable high-capacity power source.

What is claimed is:

1. A manufacturing method of a negative electrode for a non-aqueous electrolyte rechargeable battery, comprising:
mixing and performing primary kneading conductive material containing at least fibrous carbon of which aspect ratio is at least 10 and at most 10000, polymer, and a dispersion medium; and
adding active material that contains at least silicon and can store and emit a lithium ion, and another portion of the dispersion medium, and performing secondary kneading after the primary kneading.

2. The manufacturing method of the negative electrode for the non-aqueous electrolyte rechargeable battery according to claim 1,
wherein weight of the polymer in the primary kneading is 2 to 6 times larger than weight of the fibrous carbon.

3. The manufacturing method of the negative electrode for the non-aqueous electrolyte rechargeable battery according to claim 1,
wherein the fibrous carbon is at least 3.0 parts-by-weight and at most 12.0 parts-by-weight per 100 parts-by-weight of the active material.

4. A non-aqueous electrolyte rechargeable battery comprising:
a positive electrode capable of storing and emitting a lithium ion;
a negative electrode manufactured by mixing and performing primary kneading conductive material including at least fibrous carbon of which aspect ratio is at least 10 and at most 10000, polymer, and a dispersion medium, and adding active material that contains at least silicon and can store and emit a lithium ion, and another portion of the dispersion medium, and performing secondary kneading after the primary kneading; and
an lithium ion conducting electrolyte disposed between the positive electrode and the negative electrode.
